(19) United States
(12) Patent Application Publication
(10) Pub. No.: US 2018/0032618 A1
(43) Pub. Date: Feb. 1, 2018

(54) SYSTEM AND METHODS FOR RETRIEVING RAW DATA FROM UNPREDICTABLE DATA SOURCES

(71) Applicant: ALQIMI Analytics & Intelligence, LLC, Rockville, MD (US)

(72) Inventors: Walter GREENBERG, Rockville, MD (US); Kevin M. DONOHUE, Rockville, MD (US)

(21) Appl. No.: 15/224,456

(22) Filed: Jul. 29, 2016

(51) Int. Cl. G06F 17/30

(52) U.S. Cl. CPC G06F 17/30867; G06F 17/30076; G06F 17/30938; G06F 17/30941

(57) ABSTRACT

Some embodiments are directed to a method for exchanging data between a user and a data source, the method including configuring an XML data source query file stored on a portal server. The XML data source query file includes a data source query. The method can further include configuring a data source connection file stored on the portal server. The method can also include configuring a portal page configuration stored on the portal server and accessing a portlet that is intermediate between the data source and the portal page by a browser. The method can further include retrieving raw data from the data source with an input into a function made available to the browser and displaying the raw data in the browser.

### BACKGROUND

The disclosed subject matter relates to data retrieval, and more specifically to systems and methods for displaying raw data retrieved from data sources on a browser or a web portal. In particular, the disclosed subject matter relates to a portal with one or more portlets that are designed to display raw data retrieved from diverse data sources. Retrieved data is typically presented in web pages or web-based graphical user interfaces.

A web portal is a website that brings information together from diverse sources in a uniform way. Usually, each information source gets its dedicated area on the web portal for displaying information. The dedicated area may represent a portlet. Whenever a user goes online, the portal is a first visual display that the user interacts with. A portal may use a search engine to permit users to search intranet content. Apart from the common search engine features, the web portals may offer other services such as e-mail, news, stock quotes, information from database and even entertainment events.

Services relating to data retrieval can be implemented as software components that provide content and/or functionality to remote web applications through the Internet. Remote applications can submit requests for information to web services and receive content in return. Similarly, applications can pass queries to web services by deploying configuration files that contain information regarding the data source, various search filters and display options. A result is returned from the web service to the application based on the queries. Web service content can be passed to a client of the application where it can be displayed, processed, or otherwise utilized.

### SUMMARY

Various applications for retrieving data from data sources and displaying the retrieved data on user or client terminals are well known. However, each application can retrieve only a specific type of data or data from a specific data source. Further, such applications also need to be present locally on a user or a client terminal.

In some related arts, data retrieval processes are generally implemented by an application server or a servlet. The application server can be any software framework that facilitates the creation of web applications and a server environment to run them. It behaves as a virtual machine to run applications and handles connections to data sources on one end and connections to the client terminal or user terminal through a web client or web portal on the other end. However, using only the application server, a cluster of application servers or servlets can restrict dynamic delivery of information based on user preferences. Therefore, additional complex client applications are required to process the data retrieved on the server.

It may therefore be beneficial to provide systems and methods to retrieve data from multiple data sources and store the retrieved data in a local database. It may also be beneficial to provide systems and methods to retrieve data from one or more data sources in accordance with data retrieval filters.

It may also be beneficial to generate one or more portlets to facilitate retrieval of data from one or more data sources. One or more portlets can be generated by a portal server to facilitate a single point of access to data from data sources for end-users or clients.

It may also be beneficial to provide a specification-compliant, end-user-configurable portlet that allows a user to quickly access and return database data using a portal server. Using a web-interface designed for a non-technical end-user, a series of data-retrieval options may be selected or configured and saved to an Extensible Markup Language (XML) configuration file or an XML data source query file. A portal server, with the portlet installed, may be used to retrieve the data as per the configuration options stored in the XML data source query file. Examples of available configuration options can include, but not restricted to, data retrieval filters, data export formats (XML format, Comma Separated Values or CSV format), and various levels of summary and detail.

It may also be beneficial to provide systems and methods that enable a user to create one or more configuration files which dictate certain data retrieval options. For example, each configuration file corresponds to a specific user's desired search feeds and/or data retrieval options.

It may further be beneficial to provide systems and methods that can retrieve data in any format and display the data in its native format on a browser. The raw data displayed on the browser can be further modified based on user preferences.

Some embodiments are directed to a system and methods that facilitate exchange of data between a user terminal and one or more data sources, using one or more portlets installed on a portal server.

Some embodiments are directed to a method for exchanging data between a user and a data source. The method includes configuring an XML data source query file stored on a portal server, the XML data source query file including a data source query. The method further includes configuring a data source connection file stored on the portal server. The method also includes configuring a portal page configuration stored on the portal server, and accessing a portlet that is intermediate between the data source and the portal page by a browser. The method can further include retrieving raw data from the data source with an input into a function made available to the browser and displaying the raw data in the browser.

Some embodiments are directed to a method of retrieving data from a data source. The method includes receiving a data source query and data source connection information, and embedding the data source query and the data source connection information into an XML data source query file stored on a portal server. The method also includes selecting a portlet that is intermediate between the data source and a portal page. The method further includes receiving an input by a function on the portal server and calling the portlet with the function. The method also includes executing the data source query stored in the XML data source query file by the portlet, retrieving the raw data based on the execution of the data source query and displaying the raw data in a browser associated with the portal page.

Some embodiments are directed to a system for exchanging data between a user and a data source. The system includes a portal page configured to receive a data source query and data source connection information from the user, the data source query and the data source connection corresponding to a first data source. The system further includes a processor configured to generate an XML data source query file based on the data source query and the data source connection information. The system also includes a portal server communicably coupled to the portal page, the portal server configured to select a portlet that is intermediate between the data source and a portal page. The portal server is configured to receive an input from the user by a function and to call the portlet with the function. The portal server is also configured to execute the data source query stored in the XML data source query file by the portlet, retrieve the raw data based on the execution of the data source query and display the raw data in a browser associated with the portal page.

As mentioned above, the disclosed systems and methods address a problem occurring in related art processing devices that utilize data retrieval or display software, and in particular systems that employ data portal (portlet) applications. Specifically, it can be difficult to determine the exact format that a given piece of data may be received in based on a query. Factors such as language (e.g., Sanskrit, hieroglyphics, or aboriginal markings) or data format (x-ray images, facial recognition data, or even 4-dimensional star positions) could constitute data types that could be difficult for an application to interpret, but which are nonetheless desirable to retrieve and/or record. Other factors could include new, antiquated, or unforeseen computer file formats or computer languages that may be desirable to capture. Yet other formats could include abstract or esoteric mathematical formulas, stenographer shorthand, chemistry formulas or relationships, or any number of other shapes or relationships between data entries.

Some of the disclosed embodiments address this problem by providing methods and systems allowing a user to acquire a raw data dump from unknown or unrecognized data sources into a data portlet application (often a browser). This technology could provide a user with the ability to ascertain data to varying levels of detail, up to and including raw digital 0′s and l′s. However, this scheme could also be used in other layers of abstraction, such as identifying object-oriented data types with varying levels of specificity (e.g., “John. Anderson. Physical Attributes. teeth”, and then providing a data “dump” of the relevant attribute into the application.

In such a situation, it could be advantageous to create or procure software models or known algorithms to correlate the data. An additional benefit of this strategy is that a governing application would not return an error or be unable to return any information whatsoever, but simply that further processing on the returned data may be required for the information to be more viable to a user. In some instances, such as in data returned from a corrupt hard drive, a basic visual inspection could determine areas of interest (e.g., 10,000 pages of 0′s may be useless, but the next pages in the series may not) to cut down on any manual or custom automated processing time.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed and it does not limit the scope of the disclosed subject matter which is defined by the claims. Included in the drawings are the following figures:

FIGS. 1A, 1B and 1C illustrate various exemplary systems for retrieving and displaying data with a Service Integration Module Portlet (SIM) in accordance with the disclosed subject matter.

FIG. 2 illustrates the Service Integration Module Portlet (SIM) in accordance with the disclosed subject matter.

FIG. 3 is a schematic of a user interface shown on a portal page in accordance with the disclosed subject matter.

FIG. 4 is a flowchart of an exemplary method of retrieving data in accordance with the disclosed subject matter.

FIG. 5 is a flowchart of an exemplary method of retrieving data in accordance with the disclosed subject matter.

FIG. 6 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. Server Environment

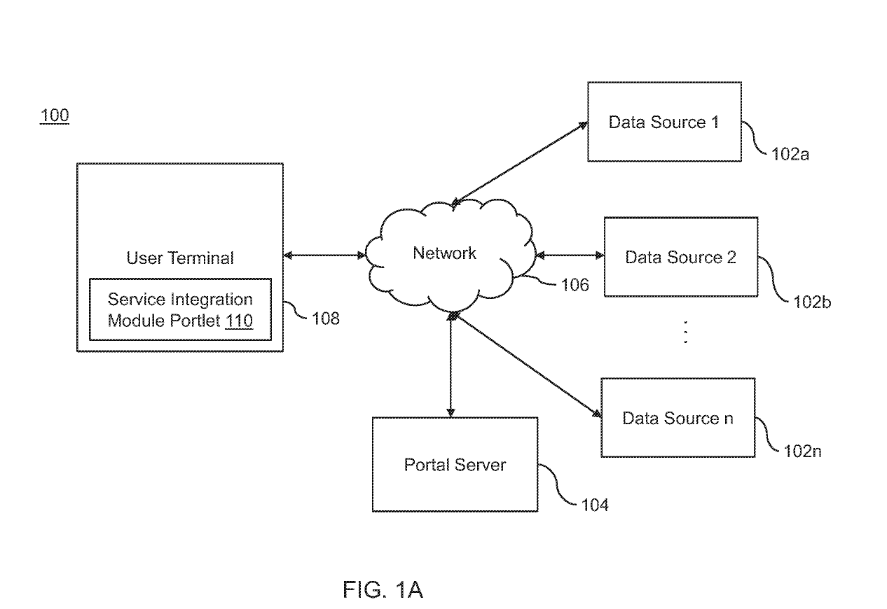

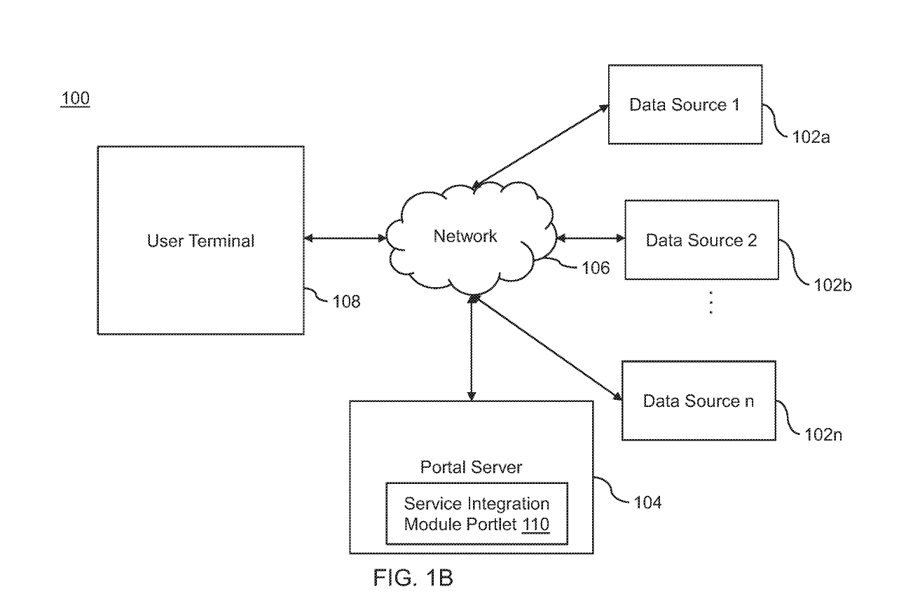

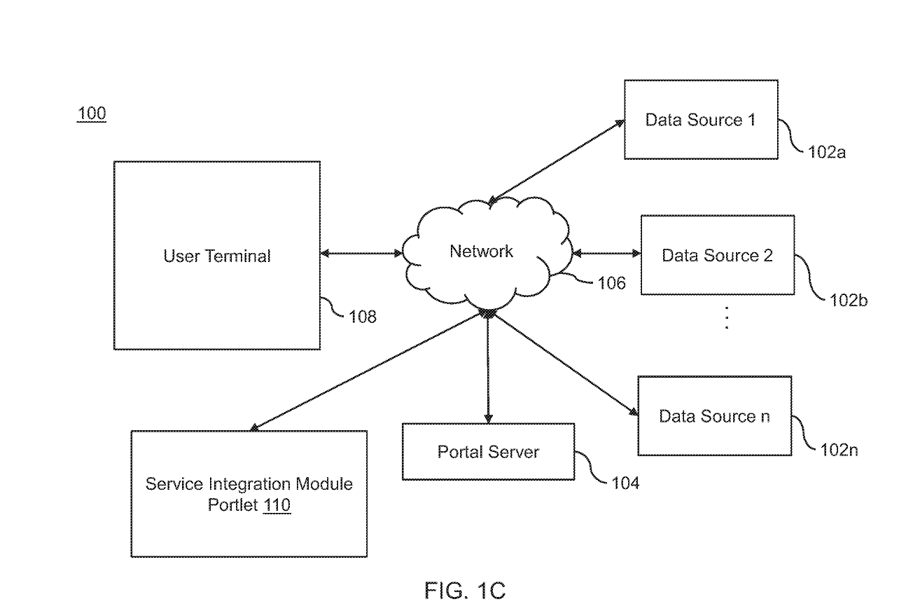

FIG. 1A is an illustration of a system 100 in accordance with the disclosed subject matter. The system 100 is configured to retrieve and display data. Specifically, the system 100 facilitates exchange of data between a user terminal 108 (hereinafter referred to as “the user 108 ”) and one or more data sources 102 through one or more portlets installed on a portal server 104. In some instances, the portal server 104 may be positioned in series with the user 108, or may even be configured as a part of the user 108 itself (such as an app, an Operating System routine, or the like). The data to be exchanged is retrieved in accordance with an Extensible Markup Language (XML) configuration file or an XML data source query file that may contain various forms of information. This information can include, but not limited to, connection information, display preference information, and user query information. The XML file can also include, but not restricted to, data retrieval filters, keywords, metadata or metadata tracking information and so forth.

The data sources 102a to 102n (hereinafter collectively termed as “the data source 102 ”) are intended to be any type of data source including social media networks, search engines, portals, remote servers, network storage units, etc. In fact, embodiments are intended to include or otherwise cover any other type of data source that can store and provide data. The data sources 102 are merely provided for exemplary purposes, and the various inventive aspects are intended to be applied to any type of data source on a communication network 106 connected to the portal server 104 and the user 108.

The network 106 may include a data network such as, but not restricted to, the Internet, local area network (LAN), wide area network (WAN), metropolitan area network (MAN), etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the data sources 102, the portal server 104 and the user 108 with each other.

The user 108 is intended to include any electronic device, such as desktop computers, portable computers, smartphones, tablet computers, wearable devices, and the like. The user 108 may also include a display unit (not shown) for displaying any data. The display unit can include, but not limited to, a Cathode Ray Tube (CRT) display, a Liquid Crystal Display (LCD), a Light Emitting Diode (LED) display, and the like. In fact, embodiments are intended to include or otherwise cover any type of display, including known, related art, and/or later developed technologies.

The portal server 104 generates a Service Integration Module Portlet 110 (hereinafter referred to as “the SIM 110 ”) that is a specification-compliant, end-user-configurable portlet that allows the user 108 to quickly access and return database data using a portal server, without programming beyond the generation of the XML data source query file. In some embodiments, the SIM 110 may be part of the user 108, as shown in FIG. 1A. In some other embodiments, the SIM 110 may be part of the portal server 104 (shown in FIG. 1B) or may be placed next to the user 108 (shown in FIG. 1C).

Through a web-interface designed for a non-technical end-user, a series of data-retrieval options may be selected (configured) and saved into an XML data source query file. Extensible Markup Language (XML) is a markup language that defines a set of rules for encoding documents in a format that is both human-readable and machine-readable. Therefore, the XML data source query file can be both human-readable and machine-readable.

In some embodiments, the XML data source query file can also be manually configured. For example, the XML data source query file may be configured in a word processing application. The portal server 104, with the SIM 110 installed, is used to retrieve the data from the various data sources 102 as per the configuration options stored in the XML data source query file. Examples of available configuration options include data retrieval filters, data export formats (XML format or .csv format), and various levels of summary and detail. The XML data source query file may also include retrieval specific guidelines, such as retrieving a type of data only from selected databases. For example, sports related data can only be retrieved from the data source 102a, while business related data is fetched from the data source 102b.

The XML data source query file may further include artistic guidelines, such as displaying a three-day weather forecast in the top-left corner of a portal page, and news in the bottom-right corner the portal page. The XML file may also be arbitrarily specific, such as weather in Seattle being displayed in the top left of the portal page, while arrest reports from anyone in Miami named “Edward” being displayed in the bottom right corner of the portal page.

In some embodiments, a processor (not shown) associated with the user 108 may generate the XML data source query file and store it on a memory (not shown) associated with the user 108. Further, the portal server 104 may be communicably coupled to the user 108 in order to access the configuration options stored in the XML data source query file. In other embodiments, the processor that generates the XML data source query file may be associated with the portal server 104.

The portal can be a web portal or an enterprise portal and is configured to aggregate data from different sources and display the aggregated data. In an embodiment, the portal is a web page that brings information together from diverse sources. Each piece of information from a specific source gets a dedicated display or presentation area on the portal as defined by an end-user or web designer. The dedicated display or presentation area is handled or managed by one or more portlets. Portlets are applications used by a data portal website to receive requests from the user 108 or a client terminal and return information. In some embodiments the portal server 104 is the middleware between an application server (not shown) and the user 108. The portal server 104 can run on top of the application server or a cluster of application servers. The application server or the cluster of application servers can host web applications related to data retrieval.

### II. Portals and Service Integration Module Portlet

A web portal is a specially designed web site that brings information together from diverse sources in a uniform way. Usually, each information source gets its dedicated area on the web site for displaying information (a portlet). Optionally, the end-user can configure which ones to display. Variants of portals include mashups and intranet “dashboards” for executives and managers. The extent to which content is retrieved may depend on the intended end-user and the intended purpose, as well as the diversity of the content. Very often retrieval emphasis is on a certain “metaphor” for recovering, and reclaiming the information content and the chosen implementation framework and/or code libraries. In addition, the role of the end-user in an organization may determine which content can be added to the portal or deleted from the portal configuration.

A portal may use a search engine application program interface (API) to permit end-users to search intranet content as opposed to extranet content by restricting which domains may be searched. Apart from this common search engines feature, web portals may offer other services such as e-mail, news, stock quotes, information from databases and even entertainment content. Portals provide a way for enterprises and organizations to provide a consistent look and feel with access control and procedures for multiple applications and databases, which otherwise would have been different web entities at various uniform resource locators (URL). The features available may be restricted by whether access is by an authorized and authenticated end-user (employee member) or an anonymous site visitor.

Portal servers provide a central platform for accessing web content and resources (data, docs, apps, integrations, alerts, etc.). A core feature of a portal is to provide a central URL that permits an end-user to have a custom web experience based upon the end-users' login identity. This functionality is termed role-based content delivery, or RBCD, and is a main focus for portals.

Websites based on Role-based Content Delivery (RBCD) allow an enterprise to develop a central web platform. Enterprises can then advertise a single website, and thereby increase the usage of the entire enterprise's resources as the central portal can integrate or guide end-users to other resources. RBCD has allowed administrators to build portal pages for different end-user types to customize the end-user experience based on an end-user's “formal identity,” such as a salesperson, engineer or manager.

Given that portal pages can include both applications (portlets and widgets) and web content, many portals have begun supporting integration to an external web content management system (WCMS) allowing content to be created or managed in a WCMS that appears in a portal page. This two-step process of adding content prompted some other portals to create an embedded WCMS.

Portals additionally have begun to focus on end-users, allowing such end-users to interact with the system. End-users are often allowed to create their own pages or sites, to add collaboration apps to those pages and to define end-user access to those pages. Many portals also enable power end-users to have added features, such as web forms, workflows, dynamic lists and polls.

This focus on enabling the end-user, combined with RBCD, allows a central site to enable both the formal organizational structure as well as the informal organizational structure (i.e. . , social collaboration) and is a major difference between portals and many WCMS systems.

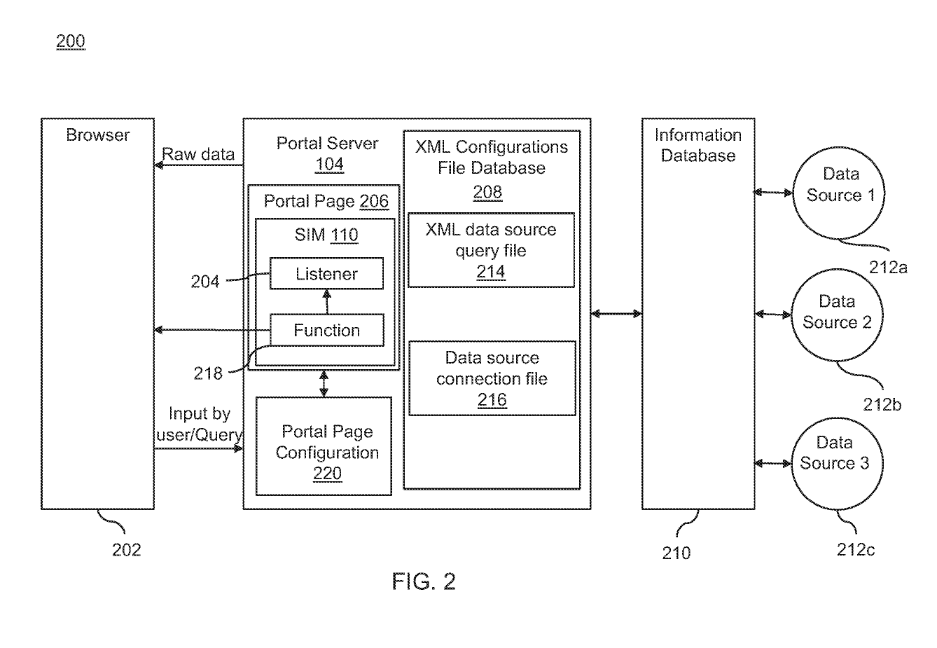

FIG. 2 illustrates a system 200 including a Service Integration Module Portlet (SIM) 110, installed and placed on the portal server 104, in conjunction with the user 108, the data source 212a, the data source 212b and the data source 212c. The data sources 212a, 212b and 212c are collectively referred to as the data source 212. The user 108 can create data source queries based on choices made on a form-based user interface by an end-user. In some embodiments, the portal server 104 may provide the form-based user interface at a browser 202 via a portal page 206. The browser 202 is a web browser application stored on the user 108. The portal page 206 is a specially design web site that brings information together from various sources in a uniform way. The portal page 206 further includes the SIM 110, a listener portlet 204, a function 218 and a portal page configuration 220. In some embodiments, the portal page 206 is stored on the portal server 104.

The portal page 206 may be displayed on the browser 202 and can receive one or more data source queries from the user 108. Each data source query can create one or more XML data source query files. The XML data source query file information includes connection information and data retrieval filters. In some embodiments, the XML data source query file may further include one or more sets of display options. The display options include, but are not limited to, at least one of a tabular layout, a chart layout, a news layout, a form layout, and a bullet layout.

Connection information includes, but is not limited to, IP addresses, subnet masks, domain name server addresses, host name and suffix, execution parameters, and system information pertaining to the user 108 and/or the portal server 104. The data retrieval filters can include one or more identities indicative of a data source illustrated in FIG. 2 as the data source 212.

The portal server 104 includes a non-transitory computer readable medium that is configured to access data from the data source 212. In other embodiments, the portal server 104 includes a non-transitory computer readable medium that is configured to access data from multiple data sources not limited to the data source 212. The non-transitory computer readable medium may be a set of instructions executable by the portal server 104 to carry out various operations including, but not limited to, accessing and retrieving data, storing data, generating portlets and displaying data through the portlets. In some embodiments, the non-transitory computer readable medium can be configured by the portal server 104 to carry out various operations. Further, configuring the non-transitory computer readable medium may include executing the instructions stored therein.

The SIM portlet 110 is installed in the portal page 206. One or more XML data source query files provide connection information, user-defined display options and data retrieval filters to the portal server 104 using the SIM 110. In some embodiments the XML data source query files are stored on a memory local to the user 108. In some embodiments the connection information, the user-defined display options and the user-defined data retrieval filters form a user-defined data source query. Each XML data source query file is extracted to an XML configurations file database 208. Further, each XML data source query file uses a single query defined by the user 108 to extract data from multiple tables within an information database 210. In some embodiments, the XML configurations file database 208 and the information database 210 may be a relational database and/or an object-relational database. The information database 210 stores the frequently used data locally so that it is made available as soon as the query is run by the user 108. In some embodiments, the SIM 110 may retrieve data in real time as per the user query received at the portal server 104. In some other embodiments, the SIM 110 may retrieve data before a user query is received at the portal server 104.

The SIM 110 is a specification-compliant, end-user-configurable portlet that serves as an intermediary between a portal page 206 and the information database 210. In some embodiments, the SIM 110 allows the user 108 to provide a data source query in order to retrieve data from the data sources 102 in a format defined in the data source query. In yet another embodiment, the SIM 110 can be used with other software modules (that could also be third-party modules) to parse and format the data in a desired way.

In some embodiments, the portal page 206 includes a portal page configuration 220 directed towards the SIM portlet 110 and a listener portlet 204 selected by the SIM 110. The portal page configuration 220 may be configured using a form displayed on the browser 202 which is populated by choices of an end-user and thereby the portal page configuration 220 enables the generation of the data source query and the selection of the listener portlet 204. The selected listener may be called via a function 218. When called via a function 218, the listener portlet 204 extracts and executes a data source query stored in one or more XML data source query files. Subsequently, the SIM 110 retrieves data from the data source 212 in accordance with the data source query and transmits the retrieved data to the browser 202. Other third party software modules may also be used by an end-user to further format and display the retrieved data as desired.

In some embodiments, the portal server 104 may generate an XML data source query file 214 with the data retrieval filters and the display options, and an XML data source connection file 216 with the connection information. The listener portlet 204 is called using the function 218 to extract information from the XML data source query file 214 and the XML data source connection file 216. The listener portlet 204 retrieves raw data from the data sources 212 via the information database 210. In some embodiments, data may be retrieved to the information database 210 prior to the listener portlet 204 being called. In other embodiments, data may be retrieved from the data source 212 to the information database 210 after the listener portlet 204 extracts the data source query from the XML data source query file 214 and the XML data source connection file 216. In some embodiments, the retrieved raw data may be in an XML format or JSON format.

In an embodiment, the user queries, the display options and the data retrieval filters may be obtained via a user interface 300 which will be described in detail hereinafter.

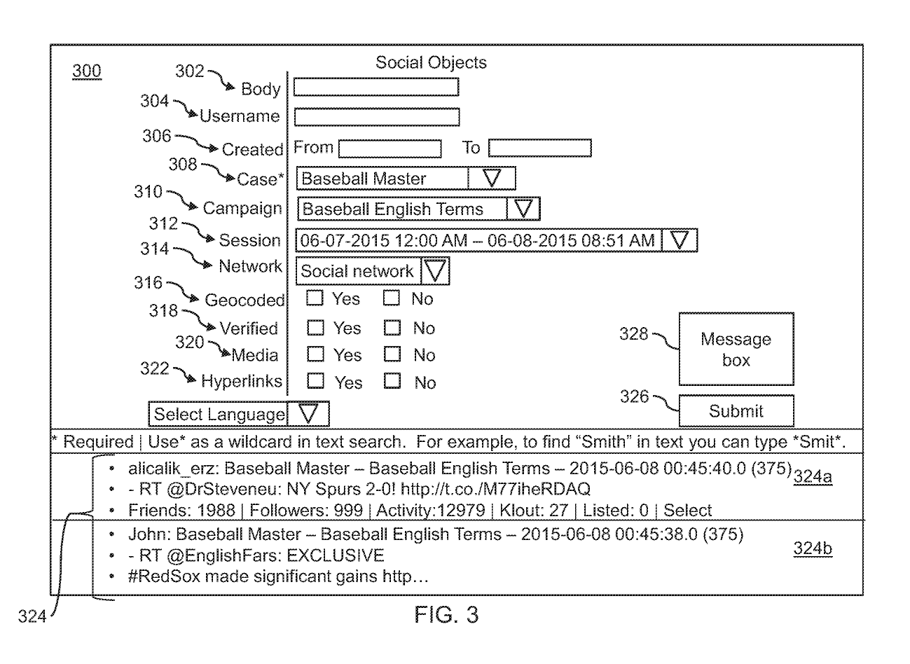

FIG. 3 illustrates an exemplary embodiment of a user interface 300 presented on the user 108. In some embodiments, the user interface 300 may be displayed on a via the portal page 206 on the browser 202. The user interface 300 includes fields for various query parameters. The fields include, but are not limited to, a body field 302, a username field 304, query creation dates field 306, a query title or case field 308, a language filter field 310, date/time stamp details field 312, a data source field 314, location filters field 316, authenticate filters field 318, a selection field 320 for the retrieval of images, and hyperlinks filters field 322 for audio/video options.

The user interface 300 also includes a submit button 326. The submit button 326 may initiate the data retrieval process. The submit button 326 may confirm the input by the user 108. The user interface 300 also includes a message box 328 which displays various messages of interest to the user 108. In some embodiments, the message box 328 can display messages related to successful generation of the data source query based on populated field 302 to 322. In some other embodiments, the message box can display an error message in the event that any of the fields 302 to 322 are not populated or wrongly filled. In yet another embodiment, the message box 328 can display a message for retrieval of data. In fact, embodiments of the disclosed subject matter are intended to include or otherwise cover any type of technology including known, related art, and/or later developed technologies, which can display messages to the user 108

The retrieved data is displayed according to choices made in the aforementioned fields at a results field 324. In some embodiments, the results field 324 is associated with one or more portlets. Each of the fields 302 to 322 and the results field 324 correspond to one or more portlets generated by the portal server 104. Further, the results are displayed through a first portlet 324a and a second portlet 324b located on the results field 324. The first and second portlets 324a, 324b may be generated by the portal server 104.

Choices made on the user interface 300 form the data source query and is embedded into an Extensible Markup language (XML) configuration file or an XML data source query file stored on the user 108. An example of the information stored in the XML data source query file is shown below:

<QuerySettings>

<DatabaseVendor>PostgreSQL</DatabaseVendor>
<Connection>

<ConnectionID>2</ConnectionID>

</Connection>
<QueryString>SELECT verifiedimg, verifiedyn, username,

displayname, authorkloutscore, useractivitycount, friends,
followers, listedcount, favoritescount, retweetcount,
generator, verified, profileimgurl, network, created, createdyear,
createdmonth, createdday, body, isre, origobjsrcid, objectsrcunid,
origauthor, sourceid, hashtags,
languages, expandedurls, verb, usermentionsnames, usermentionsids,
mediaurls, lon, lat, headline,
tagline, createdby, objectcreateddate, geocoordinates,
linktoobject, resultid, Geocoded, globe, resultid, id, userbiolocation,
mediatype, usermentionsscreennames, actorid, verified, userbiolocation,
sentiment_tag, sentiment_score, user_sentiment_votes,
user_sentiment_average, user_sentiment_mode,
user_sentiment_median, mediayn, tsv_body

The above is a snippet from an exemplary XML data source query file used in accordance with the disclosed subject matter. Each XML data source query file uses a single query received through the user interface 300 to retrieve data from multiple tables within the information database 210.

The XML data source query file is used for the processing, definition and presentation of data on the user interface 300. Through the XML data source query file, code is specified for formatting various layouts and styles pertaining to presentation of data. The XML data source query file, as seen in the sample code above, includes the user-defined query, that further includes communication information, display options and data retrieval filters, as illustrated in FIG. 2. The XML data source query file provides connection information to enable a connection between the user 108 and the information database 210 (in the current example the Information database 210 being an object-relational database provided by PostgreSQL®).

The “Querystring” tag, as shown in the snippet above, correspond to the multiple fields shown in FIG. 3 as the fields 302 to 322. The XML data source query file further acts as a tool to transport the user-defined query information from the user 108 to the XML configurations file database 208 and the information database 210. Subsequently, based on the data source query, the portal server 104 extracts the data corresponding to the retrieval filters specified at the fields 316 to 322 from the data source specified at the data source field 314. The data is extracted in a predefined format at the information database 210. Subsequently, the extracted data is presented based on the display options specified in the user-defined query through the portlets corresponding to the results field 324 as shown in FIG. 3.

In order for a single query, such as that shown in the XML sample above, to retrieve data from multiple sources, the data would need to exist in any of the data sources 212a, 212b and 212c apart from the information database 210 specified in the query.

In some embodiments, the connection information is included in the XML data source query file (as shown above). In some other embodiments, the connection information may be included in the XML data source connection file 216 separately. Further, the display options and the data retrieval filters may be stored in the XML data source query file 214. The XML data source connection file 216 deals with the connection information between the user 108 and the information database 210 and/or data sources 212. An example of the information stored in the XML data source connection file 216 is shown below:

<Connection>

<ConnectionID>2</ConnectionID>
<ConnectionSecured>yes</ConnectionSecured>
<VerifiedDatabase>yes</VerifiedDatabase>
<DatabaseSSID>PostgreSQL</DatabaseSSID>

</Connection>

In some embodiments, the XML data source query file can ensure the security of the connection and authenticity of the data source 212 (shown in FIG. 2). Further, the configuration file identifies the Service Set Identifier (SSID) for the data source 212 from which the data is to be retrieved.

### III. Exemplary Embodiments

In an exemplary embodiment, one or more XML data source query files is generated at the user 108 with a data source query embedded. The data source query includes connection information, data retrieval filters and display options. As shown in FIG. 3, the fields 302 to 322 in the user interface 300 are populated such that user-defined options relating to data retrieval filters and display options are specified. The user interface 300 is displayed on a display interface (not shown) that is included with the user 108. In accordance with the sample XML code above, the populated fields 302 to 322 enable selections of the query strings such that the data source query is created and embedded into the XML data source query file. The function may receive the input upon detection of an action on the submit button 326. In case of any errors or missing information in the populated fields 302 to 322, the function 218 may return an error message through the message box 328. The end-user may be then allowed to rectify the errors notified in the message box 328. In case all the populated fields 302 to 322 are duly filled, the function 218 may return an acknowledgement message through the message box 328. Once, the function 218 returns the acknowledge message, the function 218 may initiate data retrieval through the listener portlet 204.

In some embodiments, the portal server 104 may generate an XML data source query file 214 with the data retrieval filters and the display options, and an XML data source connection file 216 with the connection information. The listener portlet 204 is called using the function 218 to extract information from the XML data source query file 214 and the XML data source connection file 216. The listener portlet 204 can retrieve raw data from the data sources 212 via the information database 210. In some embodiments, data may be retrieved to the information database 210 prior to the listener portlet 204 being called. In other embodiments, data may be retrieved from the data source 212 to the information database 210 after the listener portlet 204 extracts the data source query from the XML data source query file 214 and the XML data source connection file 216. In some embodiments, the retrieved raw data may be in an XML format or JSON format.

Using the SIM 110 that is installed on the portal server 104, the data retrieval filters and display options contained in the XML data source query file is transmitted to the XML configurations file database 208. The information database 210, as shown in FIG. 2, stores data retrieved from the data source 212. The data may be retrieved prior to the data source query being received at the XML configurations file database 208. In some embodiments, the data may be retrieved upon receiving the data source query. The retrieved data is stored on the information database 210. Based on the data source query stored in the XML configurations file database 208, data, corresponding to the data source 212, is extracted from the information database 210 and presented on the user interface 300 (as shown in FIG. 3) at the portlets corresponding to the results field 324.

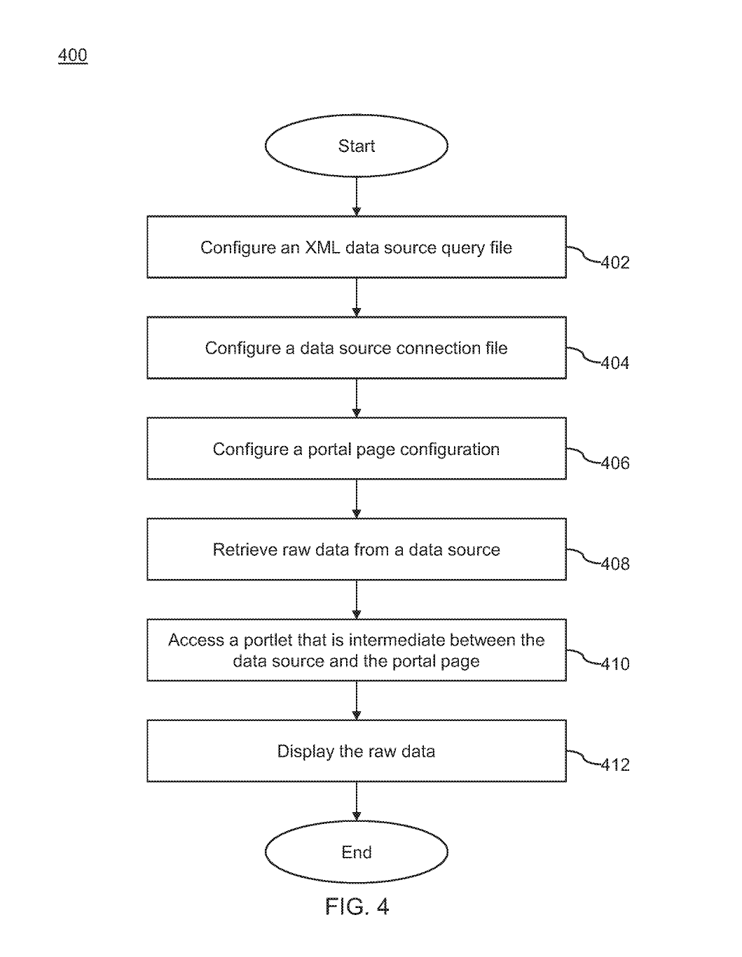

FIG. 4 illustrates a method 400 of exchanging data between the user 108 and the data source 212 in accordance with the disclosed subject matter. This flowchart is merely provided for exemplary purposes, and embodiments are intended to include or otherwise cover any methods or procedures for exchanging data between the user and the data source.

In accordance with the flowchart of FIG. 4, at step 402, the XML data source query file 214 stored on the portal server 104 is configured. In some embodiments, the XML data source query file 214 includes the data retrieval filters and the display options that are populated at the fields 302 to 322. In yet another embodiment, a processor (not shown) associated with the user 108 generates the XML data source query file and stores it on a memory (not shown) associated with the user 108. In some other embodiments, the data source query further includes an identifier, that indicates any or a combination of the data sources 212a, 212b and 212c, a set of keywords indicative of the type of data to be retrieved and a set of data retrieval filters. In yet other embodiments, the portal server 104 may configure the XML data source query file 214 based on the various parameters received through the user interface 300 displayed on the browser 202.

At step 404, the data source connection file 216, stored on the portal server 104, is configured. The data source connection file 216 includes connection information that may be any or a combination of IP addresses, subnet masks, domain name server addresses, host name and suffix, execution parameters, and system information pertaining to the user 108, the portal server 104 and the information database 210. The portal server 104 may configure the data source connection file 216 based on the connection information obtained through the user interface 300.

At step 406, a portal page configuration is configured using the user interface 300. The portal page configuration 220 enables the generation of the data source query and the selection of the listener portlet 204. The selected listener portlet 204 may be called by the function 218 upon receiving an input from the browser 202. The function 218 may be communicably coupled or made available to the browser 202. Upon being called by the function 218, the listener portlet 204 receives and executes a data source query stored in one or more XML data source query files. In some embodiments, multiple listener portlets may also be called by the function 218.

At step 408, the listener portlet 204 retrieves data from the information database 210 in accordance with the XML data source query file 214 and the data source connection file 216. In some embodiments, data is retrieved to the information database 210 from the data source 212 prior to the listener portlet 204 being called. In other embodiments, data may be retrieved from the data source 212 to the information database 210 after the listener portlet 204 extracts the data source query from the XML data source query file 214 and the XML data source connection file 216.

At step 410, the function 218 is returned to browser 202 and the SIM 110, acting as an intermediary between the data source 102 and the portal page 206, transmits the retrieved data. Further, at step 412, the retrieved raw data is displayed at the results field 324 on the browser 202. In some embodiments, the retrieved raw is transformed into a user-defined format and thereafter, the transformed data is displayed at the results field 324. In yet another embodiment, the SIM 110 can be used with other software modules (including third-party modules) to parse and format the data such that the data displayed at the results field 324 is legible or as per a desired format.

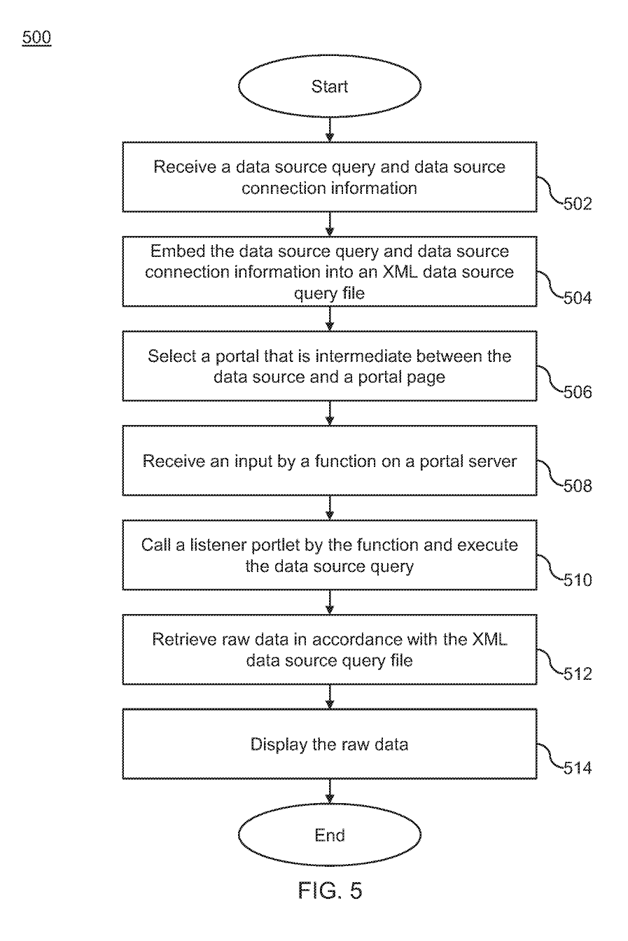

FIG. 5 is a flowchart of a method 500 for retrieving data from one or more data sources in accordance with the disclosed subject matter. At step 502, the fields 302 to 322 are populated to provide the data source query that includes data retrieval filters and display options. The data source query further includes an identifier indicative of any or a combination of the data sources 212a, 212b and 212c, a set of keywords and a set of data retrieval filters. In accordance with the identifier, data source connection information is generated at the user 108.

At step 504, the data source query and a data source connection information are embedded into an XML data source query file 214. In some embodiments, the data source query and the data source connection information may be embedded in two separate files, namely the XML data source query file 214 and the data source connection file 216, respectively. The data source query and the data source connection information are extracted to the XML configurations file database 208. At step 506, a listener portlet 204, that is intermediate between the data source 102 and the portal page 206, is selected. At step 508, the function 218 receives an input from the user interface 300. Upon populating the fields 302 to 322, an action on the submit button 326 provides the input to the function 218 that initiates the data retrieval process.

At step 510, the function 218 calls the listener portlet 204. The listener portlet 204 executes the data source query in accordance with the XML data source query file 214. Further, at step 512, the function 218 returns a message to the browser 202 through the message box 328, and the listener portlet 204 retrieves raw data from the information database 210. At step 512, the raw data is displayed on the browser 202 which is associated with the portal page 206. In some embodiments, the raw data is transformed to a user-defined format and displayed on the browser 202. In other embodiments, the system 200 may be used in conjunction with various third party software modules that enable displaying the raw data retrieved using the system 200 in a legible format on the browser 202.

### IV. Other Exemplary Embodiments

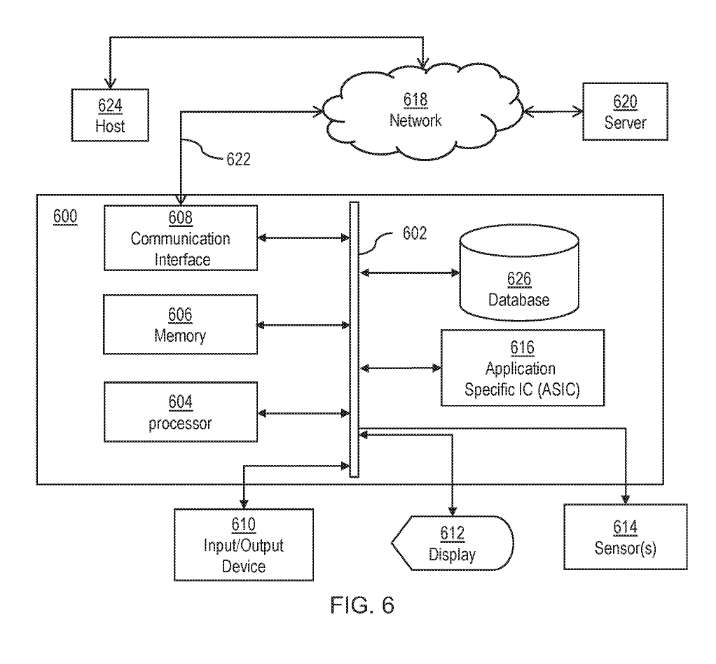

FIG. 6 illustrates a computer system 600 upon which the operation of the user 108, the SIM 110, the XML configurations file database 208, the information database 210 and the portal server 104 may be implemented. Although, the computer system 600 is depicted with respect to a particular device or equipment, it is contemplated that other devices or equipment (e.g., network elements, servers, etc.) within FIG. 6 can deploy the illustrated hardware and components of system. The computer system 600 is programmed (e.g., via computer program code or instructions) to retrieve data from the data sources 102 described herein and includes a communication mechanism such as a bus 602 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). In some embodiments, photons (or light) can be used as the data transmission medium, and may pass through fiber optic cables or even free space. Further, the presence, absence, or modulation of an electromagnetic current can encode and transport data. Still other phenomena can represent data, and any or all of these can additionally represent digits of a higher base. A superposition of multiple simultaneous quantum states before measurement can represent a quantum bit (qubit). A sequence of one or more digits constitutes digital data that is used to represent a number or code for a character. In some embodiments, information called analog data is represented by a near continuum of measurable values within a particular range. The computer system 600, or a portion thereof, constitutes a means for performing one or more steps retrieving data from one or more data sources 102.

A bus 602 includes one or more parallel conductors of information so that information is transferred quickly among devices coupled to the bus 602. A processor 604 for processing information is usually coupled with the bus 602.

The processor 604 performs a set of operations on information as specified by a user. The computer program code is a set of instructions or statements providing instructions for the operation of the processor 604 and/or the computer system 600 to perform specified functions. The code, for example, may be written in a computer programming language that is compiled into a native instruction set of the processor 604. The code may also be written directly using the native instruction set (e.g., machine language). The set of operations include bringing information in from the bus 602 and placing information on the bus 602. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 604, such as a sequence of operation codes, constitute processor instructions, also called computer system instructions or, simply, computer instructions. The processor 604 may be implemented as mechanical, electrical, magnetic, optical, chemical, or quantum components, among others, alone or in combination.

The computer system 600 also includes a memory 606 coupled to the bus 602. The memory 606, such as a Random Access Memory (RAM) or any other dynamic storage device, stores information including processor instructions for storing information and instructions to be executed by the processor 604. The dynamic memory 606 allows information stored therein to be changed by the computer system 600. RAM allows a unit of information stored at a location called a memory address to be stored and retrieved independently of information at neighboring addresses. The memory 606 is also used by the processor 604 to store temporary values during execution of processor instructions. The computer system 600 also includes a Read Only Memory (ROM) or any other static storage device coupled to the bus 602 for storing static information, including instructions, that is not changed by the computer system 600. Some memory is composed of volatile storage that loses the information stored thereon when power is lost. Also coupled to the bus 602 is a non-volatile (persistent) storage device, such as a magnetic disk, a solid state disk, optical disk or flash card, for storing information, including instructions, that persists even when the computer system 600 is turned off or otherwise loses power.

Information, including instructions for inspecting the XML data source query files is provided to the bus 602 for use by the processor 604 from an external input/output device 610. From an input perspective, the input/output device could include one or more elements such as a keyboard containing alphanumeric keys operated by a human user, a mouse, trackball, microphone, an Infrared (IR) remote control, a joystick, a game pad, a stylus pen, a touch screen, or any other of an input/output device. These devices can be capable of controlling a position of a small cursor image presented on the display 612 and issuing commands associated with graphical elements presented on the display 612.

From an output perspective, the input/output device 610 could include a Cathode Ray Tube (CRT), a Liquid Crystal Display (LCD), a Light Emitting Diode (LED) display, an organic LED (OLED) display, an active matrix display, an Electrophoretic Display (EPD), a plasma screen, or a printer for presenting text or images. Additionally, a separate display 612 may also include any of the previously mentioned devices or any other devices capable of visually, audibly, or even by means of touch, scent, etc. to provide output data to a user. Further, the display 612 may be a touch enabled display such as capacitive or resistive screen. In some embodiments, for example, in embodiments in which the computer system 600 performs all functions automatically without human input, one or more of the external input device 610, and the display 612 may be omitted.

Sensors 614 may be provided as components of the input/output device 610, or may be provided as independent components to the system 600. The sensor(s) 614 may detect conditions in its vicinity and transforms those detections into physical expressions compatible with the measurable phenomenon used to represent information in the computer system 600 such as capturing, recording and causing to store one or more still and/or moving images (e.g., videos, movies, etc.) which also may comprise audio recordings. Sensors 614 may also detect elements such as motion, temperature, imagery or video, etc.

Other external devices can also be coupled to the bus 602 such as an Application Specific IC (ASIC) device 616. In the illustrated embodiment, special purpose hardware such as the ASIC 616 might serve as special purpose hardware configured to perform operations not performed by the processor 604 quickly enough for various purposes. Examples of ASICs include graphics accelerator cards for generating images for the display 612, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 600 also includes one or more instances of a communication interface 608 coupled to the bus 602. The communication interface 608 provides a one-way or two-way communication coupling to a variety of external devices that operate with their own processors, such as printers, scanners and external disks. In general, the coupling is with a network link 618 that is connected to a local network 622 to which a variety of external devices with their own processors are connected. For example, the communication interface 608 may be a parallel port or a serial port or a Universal Serial Bus (USB) port on a personal computer. In some embodiments, the communication interface 608 is an Integrated Services Digital Network (ISDN) card, a Digital Subscriber Line (DSL) card, or a telephone modem that provides an information communication connection to a corresponding type of a telephone line. In some embodiments, the communication interface 608 is a cable modem that converts signals on the bus 602 into signals for a communication connection over a coaxial cable or into optical signals for a communication connection over a fiber optic cable. As another example, the communication interface 608 may be a Local Area Network (LAN) card to provide a data communication connection to a compatible LAN, such as Ethernet or an Asynchronous Transfer Mode (ATM) network. In one embodiment, wireless links may also be implemented. For wireless links, the communication interface 608 sends or receives or both sends and receives electrical, acoustic or electromagnetic signals, including infrared and optical signals that carry information streams, such as digital data. For example, in wireless handheld devices, such as mobile telephones like cell phones, the communication interface 608 includes a radio band electromagnetic transmitter and receiver called a radio transceiver. In certain embodiments, the communication interface 608 enables connection to the communication network 106 for inspecting the user queries in the XML data source query files. Further, the communication interface 608 can include peripheral interface devices, such as a thunderbolt interface, a Personal Computer Memory Card International Association (PCMCIA) interface, etc. Although a single communication interface 608 is depicted, multiple communication interfaces can also be employed.

The term “computer-readable medium” as used herein refers to any medium that participates in providing information to the processor 604, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device. Volatile media include, for example, the dynamic memory 606. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 616.

The network link 618 typically provides information communication using transmission media through one or more networks to other devices that use or process the information. For example, the network link 618 may provide a connection through the local network 622 to a host computer 624 or to ISP equipment operated by an Internet Service Provider (ISP).

A computer called a server host 620, connected to the Internet, hosts a process that provides a service in response to information received over the Internet. For example, the server 620 hosts a process that provides information representing video data for presentation at the display 612. It is contemplated that the components of the computer system 600 can be deployed in various configurations within other computer systems, e.g., the host 624 and the server 620.

At least some embodiments of the invention are related to the use of the computer system 600 for implementing some or all of the techniques described herein. According to one embodiment of the invention, those techniques are performed by the computer system 600 in response to the processor 604 executing one or more sequences of one or more processor instructions contained in the memory 606. Such instructions, also called computer instructions, software and program code, may be read into the memory 606 from another computer-readable medium such as the storage device or the network link 618. Execution of the sequences of instructions contained in the memory 606 causes the processor 604 to perform one or more of the method steps described herein. In alternative embodiments, hardware, such as the ASIC 616, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 604 for execution. For example, instructions and data may initially be carried on a magnetic disk of a remote computer such as the host 624. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 618. An infrared detector serving as the communication interface 608 receives the instructions and data carried in the infrared signal and places information representing the instructions and data onto the bus 602. The bus 602 carries the information to the memory 606 from which the processor 604 retrieves and executes the instructions using some of the data sent with the instructions. The instructions and data received in the memory 606 may optionally be stored on the storage device, either before or after execution by the processor 604.

### V. Alternative Embodiments

While certain embodiments of the invention are described above, and FIGS. 1A to 6 disclose the best mode for practicing the various inventive aspects, it should be understood that the invention can be embodied and configured in many different ways without departing from the spirit and scope of the invention.

For example, embodiments are disclosed above in the context of retrieving data from one or more data sources based on user queries embedded in XML data source query files. However, embodiments are intended to include or otherwise cover any type of configuration file.

Embodiments as disclosed above allow retrieval of data from different data sources and display of the raw data through a portal server and an associated portlet. Embodiments of the present disclosure further enable the portal server to be a single point of access in data retrieval and display without using any additional resources or applications on an end-user terminal.

Embodiments are also intended to cover retrieval and display of data in its native format through a portal server and associated listener portlets. Specifically, embodiments of the present disclosure allow retrieval and display of data in any non-standardized format.

Embodiments are also intended to cover storing retrieved data in any predefined format in a database associated with the portal server such that the data can be displayed through portlets generated by the portal server. The predefined format can be based on a type of data source and user-defined data fields provided in an XML data source query file.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for exchanging data between a user and a data source, the method comprising:
configuring an XML data source query file stored on a portal server, the XML data source query file including a data source query;
configuring a data source connection file stored on the portal server;
configuring a portal page configuration stored on the portal server;
accessing a portlet that is intermediate between the data source and the portal page configuration by a browser;
retrieving raw data from the data source with an input into a function made available to the browser; and
displaying the raw data in the browser.

2. The method of claim 1, further comprising:
configuring the portlet on the portal page in accordance with the XML data source query file;
calling the portlet with the function;
executing the data source query stored in the XML data source query file by the portlet; and
retrieving the raw data based on the execution of the data source query.

3. The method of claim 1, further comprising receiving the input from the user at the portal page.

4. The method of claim 1, wherein the portlet is a listener portlet configured to be called by the function.

5. The method of claim 1, wherein the function is a JavaScript function.

6. The method of claim 1, wherein the raw data is in an XML format or a JSON format.

7. The method of claim 1, further comprising:
transforming the raw data to a user-defined format; and
displaying the transformed data in the user-defined format in the browser.

8. The method of claim 1, further comprising storing the XML data source query file in a memory local to the user.

9. The method of claim 1, further comprises accessing the data source connection file in the portal server to retrieve the raw data from the data source.

10. The method of claim 1, wherein the data source query comprises an identifier indicative of the data source, a set of keywords and a set of data retrieval filters.

11. A method of retrieving data from a data source, the method comprising:
receiving a data source query and data source connection information;
embedding the data source query and the data source connection information into an XML data source query file stored on a portal server;
selecting a portlet that is intermediate between the data source and a portal page;
receiving an input by a function on the portal server;
calling the portlet with the function;
executing the data source query stored in the XML data source query file by the portlet;
retrieving the raw data based on the execution of the data source query; and
displaying the raw data in a browser associated with the portal page.

12. The method of claim 11, further comprising receiving the input at the portal page.

13. The method of claim 11, wherein the portlet is a listener portlet configured to be called by the function.

14. The method of claim 11, wherein the function is a JavaScript function.

15. The method of claim 11, wherein the raw data is in an XML format or a JSON format.

16. The method of claim 11, further comprising:
transforming the raw data to a user-defined format; and
displaying the transformed data in the user-defined format in the browser.

17. The method of claim 11, wherein the data source query comprises an identifier indicative of the data source, a set of keywords and a set of data retrieval filters.

18. A system for exchanging data between a user and a data source, the system comprising:
a portal page configured to receive a data source query and data source connection information from the user, the data source query and the data source connection corresponding to a first data source;
a processor configured to generate an XML data source query file based on the data source query and the data source connection information;
a portal server communicably coupled to the portal page, the portal server configured to:
select a portlet that is intermediate between the data source and a portal page;
receive an input from the user by a function;
call the portlet with the function;
execute the data source query stored in the XML data source query file by the portlet;
retrieve the raw data based on the execution of the data source query; and
display the raw data in a browser associated with the portal page.

19. The system of claim 18, wherein the portal server is further configured to:
transform the raw data to a user-defined format; and
display the transformed data in the user-defined format in the browser.

20. The system of claim 18, wherein the function is a JavaScript function.
